(19) United States
(12) Patent Application Publication
(10) Pub. No.: US 2004/0207168 A1
(43) Pub. Date: Oct. 21, 2004

(54) Mobile delivery cart with vertically moveable inner frame

(76) Inventors: Michael Franz Raab, Bethlehem, PA (US); Benjamin Jonathan Raab, Sanibel, FL (US)

Correspondence Address: Michael F. Raab, 551 HIDEAWAY COURT, SANIBEL, FL, 33957, US

(21) Appl. No.: 10/412,843

(22) Filed: Apr. 15, 2003

(51) Int. Cl. B62B 3/00

(52) U.S. Cl. 280/79.2

(57) ABSTRACT

A mobile delivery cart for the distribution of removable trays. The mobile delivery cart that is the object of this inventions contains a vertically moveable inner frame section which allows the loading and unloading of removable trays with decreased bending down and rising up. This also decreases the time needed for the loading and unloading of trays. The device includes an outer frame and an inner frame. The outer frame contains a plurality of tray supports in the top portion. The inner frame contains a plurality of tray supports. The inner frame is vertically mobile within the outer frame. The inner frame is moved to the top of the cart for loading and is loaded first. Once loading of the inner frame is completed it is moved to the bottom of the cart. The tray supports within the outer frame are then available to allow the upper portion of the cart to be loaded. Unloading is the reverse of loading. Because the two sections of the mobile cart that is the object of this invention are independent there is increased flexibility available to simultaneously transport a variety of items including those of different temperatures.

### BACKGROUND OF THE INVENTION

1. Field of the Invention

Mobile Delivery Carts Used to Transport Removable Trays.

This invention relates to the field of devices used to transport removable trays. These trays may contain a variety of items, including but not limited to, meals in hospitals and nursing homes. The information discovered by PTO search of the terms: carts, cart racks, delivery racks, catering carts, pan racks and dumb waiters was related to devices used to transport, heat, cool, maintain temperature and deliver meals. Search of the database revealed the following patents.

U.S. Patent Documents:

| | | | |
|---|---|---|---|
| 3240544 | Mar. 15, 1966 | JT Heckel, Jr. | 312/403 |
| 3255812 | Jun. 14, 1966 | Bayane | 165/265 |
| 4171151 | Oct. 16, 1979 | Luck | 312/236 |
| 4316078 | Feb., 1982 | Mack | 219/386 |
| 4936377 | Jun. 26, 1990 | DeVogel | 165/47 |
| 5895104 | Apr., 1999 | Grandi | 312/403 |
| 6234498 | May 22, 2001 | Saku | 280/47.34 |
| 6344630 | Feb. 5, 2002 | Jarvis | 219/386 |
| 6376803 | Apr. 23, 2002 | Klinger | 219/387 |
| 6392201 | May 21, 2002 | Owens | 219/387 |
| 6409186 | Jun. 25, 2002 | Bennington | 280/43.23 |

U.S. Pat. No. 3,240,544—describes a mobile cart with two compartments each with a hot and cold zone.

U.S. Pat. No. 3,255,812—describes a mobile cart able to serve either hot or cold foods

U.S. Pat. No. 4,171,151—describes a mobile cart with a wedge shaped configuration to improve stability of trays during transport

U.S. Pat. No. 4,316,078—describes a mobile cart which is self-propelled using a battery for power with the additional capability of being able to heat the items on the trays being transported

U.S. Pat. No. 4,936,377—describes a mobile cart comprised of phase change thermal materials to improve the ability of the device to maintain the temperature of the foods being transported.

U.S. Pat. No. 6,234,498—describes a mobile cart having an added bumper structure to protect the outside panels.

U.S. Pat. No. 6,344,630—describes a mobile cart with insulation and conductors to hold trays, maintain food temperature and food moisture without the need for a humidifier.

U.S. Pat. No. 6,376,803—describes a mobile cart adapted to hold and heat individual portioned food dishes.

U.S. Pat. No. 6,392,201—describes a mobile cart with a thermal transfer unit and a plurality of shelves adapted for catering rather than transportation of trays.

U.S. Pat. No. 6,409,186—describes a mobile cart that is motorized and contains a means to raise and lower the housing as well as the mechanism for powering movement from one area to another.

All the above devices have fixed tray supports. This forces the person handling the device into the uncomfortable position of having to bend down and rise up in order to load and unload trays.

U.S. Pat. No. 5,895,104—describes a mobile cart that has tray holders fixed onto a movable internal chain. A pedal is used to move the chain resulting in the presentation of trays to a fixed height opening in the cart. The trays are removed one by one from a constant level. Disadvantages are those related to the fact that only one tray is accessible at a time. This makes it difficult to find a specific tray among those being transported. A second disadvantage is the cart has one cavity and therefore can only have one temperature at a time. This creates a problem when some trays contain items that need to be kept warm and others contain items that need to be kept cold.

### BRIEF SUMMARY OF THE INVENTION

The device that is the object of this invention is intended to facilitate the loading and unloading of trays from mobile delivery carts by decreasing the need to bend down and rise up when loading and unloading the trays. This bending is time consuming and may be physically stressful. This device uses a vertically mobile inner frame held within the outer frame of a mobile cart. The inner frame has fixed tray supports, which replace the plurality of lower tray supports of a mobile cart. The inner frame moves to the top of the cart to eliminate most of the bending necessary to load and unload trays from the lower portion of a mobile cart. Raising the trays in the inner frame will make their loading and unloading easier and faster. A mechanism, which would vary with the size and weight of items to be carried, may be added to facilitate or prevent movement of the inner frame. The outer frame continues to have tray supports in the upper portion. These tray supports are adapted to not obstruct the vertical movement of the inner frame. This invention would allow temperatures within the inner and outer frames to be independently controlled by adding heating and cooling elements. Construction materials, including those to enclose and insulate the sides, top, bottom, front doors and back are selected based on the projected use of the cart. The materials used, adding systems for temperature control, adding a means to make the mobile cart self propelled or adding a mechanism to facilitate movement of the inner frame do not effect what is claimed by this invention.

### BRIEF DESCRIPTION OF THE DRAWINGS

FIG. 1 is a schematic front perspective view of the delivery rack with the inner frame in the up position.

FIG. 2 represents the same device from the same perspective but with the inner frame in the down position.

### DETAILED DESCRIPTION OF INVENTION

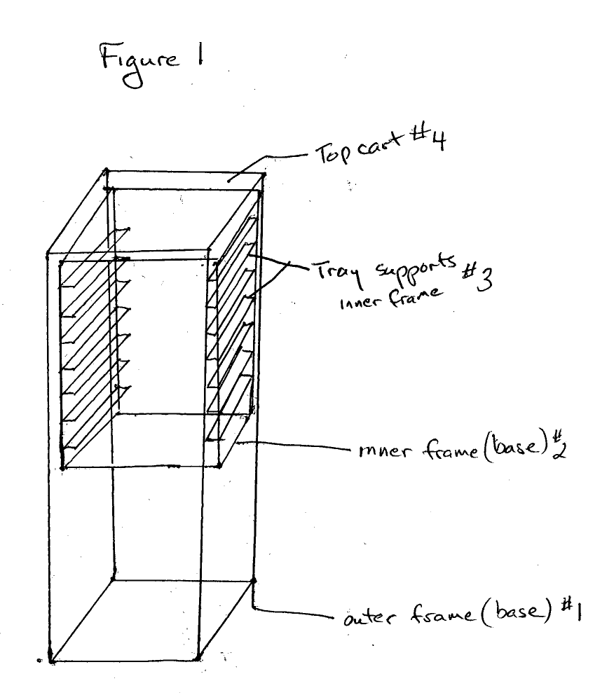

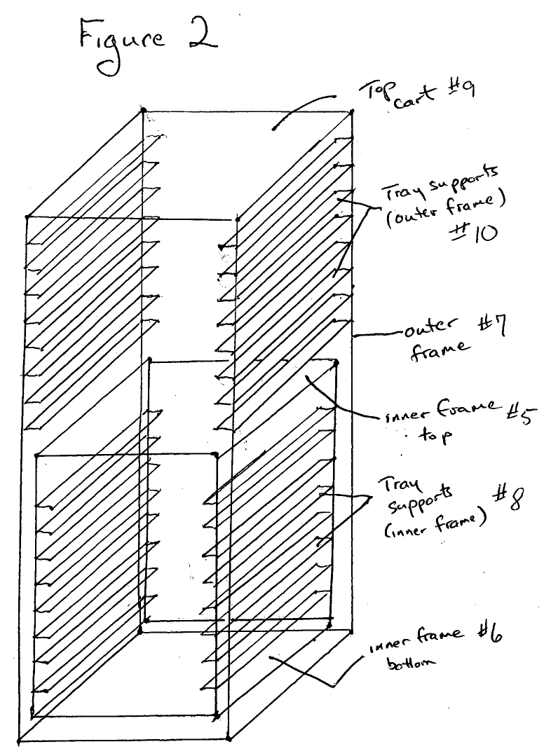

The invention is a mobile delivery cart for the distribution of removable trays. It consists of an outer frame (FIG. 1-#1) and a vertically moveable inner frame (FIG. 1-#2). This decreases the amount of bending down and rising up needed to load and unload the removable trays. The most common anticipated use of this device would be for the delivery of meals. Trays would be initially loaded into the inner frame while it is locked at the top of the cart (FIG. 1). Once loaded the inner frame is moved to the bottom of the mobile cart (FIG. 2). Trays are then loaded into the top portion of the mobile cart also called the outer frame. Unloading would reverse the loading process.

The projected use of the mobile cart determines the materials used in construction the desirability of having insulated top, bottom, sides, back and doors; the addition of heating and cooling systems and the addition of a motor for self-propulsion do not alter the intent of this invention.

FIG. 1 is a schematic perspective representation of the delivery cart. This view shows the inner frame at the top (FIG. 1-#4) of the mobile cart. There are no sides or tray supports shown on the outer frame. The fixed inner frame tray supports ((FIG. 1-#3) are shown.

FIG. 2 is the same view shown in FIG. 1. The inner frame top (FIG. 2-#5) and bottom (FIG. 2-#6) are shown at the bottom of the outer frame (FIG. 2-#7). The tray supports of the inner frame (FIG. 2-#8) are shown. The tray supports of the outer frame (FIG. 2-#10) are visible at the top of the cart (FIG. 2-#9) when the inner frame is at the bottom of the cart.

I claim:

1) The object of this invention is to decrease the bending and rising people need do to load and unload removable trays transported by a mobile cart.
a—The mobile cart is moved by users on appropriate casters.
b—The mobile cart may be self-propelled.
c—The mobile cart consists of an outer frame containing a vertically mobile inner frame.
d—The inner frame and upper portion of outer frame contain a plurality of tray supports.
e—The mobile cart outer frame tray supports do not obstruct vertical movement of the inner frame.
f—Individual trays are introduced through an opening in the top portion of the outer frame and front of the inner frame.
g—An appropriate mechanism may be added to assist and ease the vertical movement of the inner frame.
h—An appropriate method may be used to fix the inner frame in a desired position.

2) The object of this invention is to isolate two portions of one mobile cart increasing flexibility of use.
a. The inner frame may have insulated sides, top, bottom, back and front doors.
b. The inner frame may have heating elements.
c. The inner frame may have cooling elements.
d. The outer frame may have insulated sides, top, bottom, back and front doors.
e. The outer frame may have insulated sides, top, bottom, back and front doors of only its top portion
f. The outer frame may have heating elements.
g. The outer frame may have cooling elements.
h. The upper portion of the outer frame may be thermally isolated from the lower portion.
i. The inner and outer frame temperatures may be independently controlled.

3) Reference to claim 1; the object of this invention is to decrease the amount of time needed to load and unload trays from the cart.

4) Reference to claim 2; the object of this invention allows one mobile cart to be configured for more than one use.
a. The shelf heights can be different for the outer and inner frames.
b. The shelf strength and materials can be different for the outer and inner frames.
c. Both outer and inner frames can be independently heated and cooled.
d. Both outer and inner frames can be independently insulated.
e. The inner and outer frames can be used to transport items of different temperature and items of the same temperature.
f. The inner and outer frames can be used to transport items of different size and items of the same size.
g. The inner and outer frames can be used to transport items of different weight and items of the same weight.
